(19) United States
(12) Patent Application Publication
(10) Pub. No.: US 2011/0005466 A1
(43) Pub. Date: Jan. 13, 2011

(54) ANIMAL TRAVEL CARRIER

(76) Inventor: SUSAN FURTH, Greenwich, CT (US)

Correspondence Address: ECKERT SEAMANS CHERIN & MELLOTT, LLC, U.S. STEEL TOWER, 600 GRANT STREET, PITTSBURGH, PA, 15219-2788, US

(21) Appl. No.: 12/784,773

(22) Filed: May 21, 2010

Related U.S. Application Data
(60) Provisional application No. 61/270,316, filed on Jul. 7, 2009.

(51) Int. Cl. A01K 1/03; G01C 21/00; H04N 7/18; H03F 99/00; H04B 3/00; F21V 15/02

(52) U.S. Cl. 119/496; 701/213; 219/201; 62/3.1; 348/158; 381/120; 381/77; 362/375; 348/E07.088

(57) ABSTRACT

A travel carrier suitable for use in transporting a live animal via a mode of transportation, comprises an enclosure of suitable size and shape for a live animal; a power source; a video camera connected to the power source and arranged in the enclosure for capturing a video image of the animal in the enclosure; and an RF transmitter. The transmitter, which is operatively connected to the video camera, transmits a signal representing a video image of the animal to a remote receiver. The carrier may also comprise a GPS unit disposed on or in the enclosure, which is operatively connected to a transmitter, for transmitting a signal representing the location of the carrier to the remote receiver.

### CROSS-REFERENCE TO RELATED APPLICATION

This application is based upon and claims the benefit of the priority of U.S. Provisional Patent Application Ser. No. 61/270,316, filed Jul. 7, 2009, incorporated herein by reference in its entirety.

### FIELD OF THE INVENTION

The present invention relates generally to animal carriers. More specifically, the present invention relates to a portable animal travel carrier that comprises a video camera, a potable, temperature regulated water supply, interior temperature regulation or control, and a transmitter for viewing the animal.

### BACKGROUND OF THE INVENTION

There are many stories, in the commercial airline industry, of dogs, cats, birds, and other domestic animals, sickened, overheated, or frozen to death, during their transit in the cargo/baggage compartments of commercial airliners. Most IATA carriers no longer accept live animals for travel during the summer and winter months, due to the extreme ambient temperatures “on ramp”, aboard the aircraft, or in cargo facilities and hangars where the animals must be kept, often up to 3 or 4 hours before even boarding the aircraft. Also, a substantial number of international carriers do not allow live animals in the passenger cabin, due primarily to individual airline regulations, aircraft equipment compatibility, and length of haul. This often applies even if the live animal is within the height and weight limitations for “on board live animals” and would indeed fit under a cabin seat.

These circumstances have made it nearly impossible to safely transport a live animal on passenger aircraft, unless it can fit under the seat of each cabin of the aircraft. In addition, passenger airlines often have a limit on how many live animals can be on board the aircraft in passenger compartments during each flight.

When animals such as pets are transported, they are often transported in standard animal carriers of various sizes. Such carriers typically have a polymeric housing comprised of two shell sections that are releasably attached together, with a door at one end for access.

These standard animal carriers perform a basic function of transporting an animal. However, if the animal carrier is loaded on an aircraft or otherwise inaccessible to the animal's owner, the owner has no idea of the condition of the animal or its environment and has no way to control it.

### OBJECTS OF THE INVENTION

It is an object of the invention to provide an improved animal travel carrier.

It is also an object of the invention to provide an animal travel carrier having a video camera and a transmitter.

It is a further object of the invention to provide an animal travel carrier having a GPS system.

It is a further object of the invention to provide an animal travel carrier having a potable, temperature regulated water supply.

It is a further object of the invention to provide an animal travel carrier having interior temperature regulation or control.

It is a further object of the invention to provide an animal travel carrier having a climate control system comprising a heating and/or cooling system.

It is a further object of the invention to provide an animal travel carrier having a temperature sensor and a transmitter.

It is a further object of the invention to provide an animal travel carrier having an electric lighting system.

It is a further object of the invention to provide an animal travel carrier wherein an animal owner can communicate with, that is, speak to, or hear, the animal in the animal travel container.

These and other objects of the invention will become more apparent from the discussion below.

### SUMMARY OF THE INVENTION

According to the invention, an animal travel carrier comprises a self-contained, air travel enclosure or container with a video camera and a transmitter, optionally with a climate control system, that is, a heating and/or cooling system. This animal travel container or carrier is intended for the safe and comfortable transport of live, amphibious or non-amphibious animals, as well as live fish. Designed and manufactured in accordance with the very high standards required for air travel and airport “on ramp” handling, the animal travel carrier of the invention maintains the highest degree of safety, integrity, health, and security of live animals in transit.

Different sizes and shapes of the travel container of the invention are envisioned for use on narrow and wide body commercial aircraft as well as some private aircraft. The animal travel carrier will be powered by an IATA-approved energy source and maintain a proper temperature range, suitable for the healthy and safe transport of live animals up to 150 lbs. Temperature and potable water levels, as well as an animal's location, are monitored by remote access. All such pertinent data are made available to an accompanying passenger on board the commercial flight on which the animal is traveling. If the animal is unaccompanied, this information is made available to a principal designated contact on the ground.

The interest, both commercial and humanitarian, in maintaining the good health and safety of live animals in transit is extremely high. For consumers worldwide, running the gamut from commercial breeders to airline passengers, the animal travel carrier facilitates, and, in many cases, allows, for airline transport not otherwise possible.

The animal travel carrier of the invention, not only maintains proper conditions preventing pathologies, and even loss of life, during commercial air transportation, it also provides constant relevant information as to the status and well being of the animal in transit. Commercial airlines can assure customers, and their animals, safe travel year-round. This provides a valuable service and a substantial revenue opportunity for commercial and cargo airlines.

In an embodiment of the invention, an animal travel carrier suitable for transporting a live animal via a mode of transportation comprises:
an enclosure or container of suitable size and shape for a live animal;
a source of electric power;
a video camera connected to the battery and arranged in the enclosure for providing a video image of the animal in the enclosure; and
a short range transmitter for transmitting a signal representing the video image to a remote receiver.

In another embodiment of the invention, the carrier comprises one or more batteries.

In another embodiment of the invention, the video camera is connected to or contains one or more batteries.

In another embodiment of the invention, the short range transmitter is connected to or contains one or more batteries.

In another embodiment of the invention, the carrier has a potable, temperature regulated water supply.

In another embodiment of the invention, the animal's owner can communicate with, that is, speak to, or hear, the animal in the animal travel container.

In another embodiment of the invention, the animal travel carrier further comprises a GPS unit disposed on or within the enclosure, and a transmitter coupled to the GPS unit for transmitting a signal representing the location of the enclosure to a remote receiver. Optionally the GPS unit comprises or is coupled to a timed or automated on/off switch, to allow suspension and/or resumption of GPS transmission. For example, the GPS unit can be programmed to suspend transmission at a set time, such as 30 minutes, before an aircraft leaves its gate and/or to resume transmission at a set time, such as 30 minutes, after the aircraft is to scheduled to land. The GPS unit can be in the “on” mode after the aircraft lands, similar to a cell phone or other electronic device. This availability of flight arrival status and other information will be a source of great comfort to animal owners awaiting the arrival of their animals. Optionally, the GPS unit may be responsive to the receipt of a wirelessly transmitted coded signal, to turn the unit on and off.

In another embodiment of the invention, the animal travel carrier further comprises a temperature sensor disposed on or within the enclosure, and a transmitter coupled to the temperature sensor for transmitting a signal representing the temperature inside the enclosure to a remote receiver.

In another embodiment of the invention, the animal travel carrier further comprises an electric heating device disposed on or within the enclosure.

In another embodiment of the invention, the animal travel carrier further comprises an electric cooling device disposed on or within the enclosure.

In another embodiment of the invention, the animal carrier further comprises a thermostat for controlling the heating device and/or the cooling device to maintain a desired temperature range within the enclosure.

In another embodiment of the invention, the animal travel carrier further comprises an electric light disposed within the interior of the enclosure. Optionally, the electric light is coupled to a transmitter for transmitting a signal representing the status of the light to a remote receiver.

In an embodiment of the invention, an animal travel carrier suitable for transporting a live animal via a mode of transportation comprises:
an enclosure of suitable size and shape for a live animal;
a video camera arranged in the enclosure for providing a video image of the animal in the enclosure; and
a short range transmitter for transmitting a signal representing the video image to a remote receiver.

In another embodiment of the invention, the animal travel carrier further comprises:
a video control unit connected to the video camera; and
a receiver connected to the video control unit,
wherein the receiver is capable of receiving an external control signal to control the video camera.

In another embodiment of the invention, the animal travel carrier further comprises a listening device connected to a battery and arranged in the enclosure, for detecting sound in the interior of the enclosure.

In another embodiment of the invention, the animal travel carrier comprises:
a speaker or other sound-producing device connected to an amplifier; and
a receiver connected to the amplifier,
wherein the receiver is capable of receiving an external signal to be sounded through the speaker or other sound-producing device.

In another embodiment of the invention, a system for transporting a live animal comprises:
(1) a travel carrier for use in transporting a live animal via a mode of transportation, the container comprising:
   (a) an enclosure of suitable size and shape for a live animal;
   (b) a video camera arranged in the enclosure for capturing a video image of the live animal in the enclosure; and
   (c) a short range transmitter connected to the video camera, for transmitting a signal representing said video image to a remote receiver;
(2) a receiver disposed remotely from the enclosure, for receiving the signal from the transmitter; and
(3) an image display unit coupled to the receiver, for displaying the video image.

In another embodiment of the invention, the transport system comprises one or more batteries.

In another embodiment of the transport system of the invention, the video camera is connected to or contains one or more batteries.

In another embodiment of the transport system of the invention, the short range transmitter is connected to or contains one or more batteries.

In another embodiment of the transport system of the invention, the travel carrier further comprises a GPS unit disposed on or within the enclosure, and a transmitter coupled to the GPS unit for transmitting a signal representing the location of the enclosure to a remote receiver.

In another embodiment of the transport system of the invention, the travel carrier further comprises a temperature sensor disposed on or within the enclosure, and a transmitter coupled to the temperature sensor for transmitting a signal representing the temperature inside the enclosure to a remote receiver.

In another embodiment of the transport system of the invention, the travel carrier further comprises an electric heating device disposed on or within the enclosure.

In another embodiment of the transport system of the invention, the travel carrier further comprises an electric cooling device disposed on or within the enclosure.

In another embodiment of the transport system of the invention, the travel carrier further comprises a thermostat for controlling the heating device and/or the cooling device maintain a desired temperature range within the enclosure.

In another embodiment of the transport system of the invention, the travel carrier further comprises an electric light disposed within the interior of the enclosure. Optionally, the electric light is coupled to a transmitter for transmitting a signal representing the status of the light to a remote receiver.

In another embodiment of the transport system of the invention, the travel carrier further comprises a temperature sensor disposed in the enclosure, wherein the temperature sensor is coupled to the transmitter for transmitting a signal representing the temperature inside the enclosure to the receiver, and wherein the image display unit is operative to display the temperature.

In another embodiment of the transport system of the invention, the travel carrier comprises:
a video control unit connected to the video camera; and
a receiver connected to the video control unit,
wherein the receiver is capable of receiving an external control signal to control the video camera.

In another embodiment of the transport system of the invention, the remote receiver is coupled to the image display unit via the Internet.

In another embodiment of the transport system of the invention, the travel carrier further comprises a listening device connected to a battery and arranged in the enclosure, for detecting sound in the interior of the enclosure.

In another embodiment of the transport system of the invention, the travel carrier further comprises a speaker or sound producing unit connected to a battery and arranged in the enclosure, for generating sound in the enclosure.

In a particular embodiment of the transport system of the invention, the travel carrier comprises:
a speaker or other sound-producing device connected to an amplifier; and
a receiver connected to the amplifier,
wherein the receiver is capable of receiving an external signal to be sounded through the speaker or other sound-producing device.

For a full understanding of the present invention, reference should now be made to the following detailed description of the preferred embodiments of the invention as illustrated in the accompanying drawings.

### BRIEF DESCRIPTION OF THE DRAWINGS

FIG. 1 is a schematic representation of a system for transporting a live animal, according to a preferred embodiment of the invention.

FIG. 2 is a lateral view of a travel carrier according to the invention.

FIG. 3 is a top view of the travel carrier shown in FIG. 2.

FIG. 4 is a front view of the travel carrier shown in FIG. 2.

FIG. 5 is a rear view of the travel carrier shown in FIG. 2.

FIG. 6 is a cross-sectional lateral view of the travel carrier shown in FIG. 2.

FIG. 7 is a schematic representation of an embodiment of the invention where a video camera sends a signal to a remote receiver.

FIG. 8 is a schematic representation of an embodiment of the invention where a temperature sensor sends a signal to a remote receiver.

FIG. 9 is a schematic representation of an embodiment of the invention where a microphone sends a signal to a remote receiver.

FIG. 10 is a schematic representation of an embodiment of the invention where a remote transmitter sends a signal to a speaker within the air travel carrier.

FIG. 11 is a schematic representation of an embodiment of the invention where a single device is capable of sending a signal to a remote receiver and of generating sound based upon a signal received from a remote transmitter.

FIG. 12 is a schematic representation of an embodiment of the invention where a thermostat sends a signal to a remote receiver and adjusts an HVAC system within the air travel carrier.

FIG. 13 is an embodiment of a receiver used with the travel carrier and system according to the invention.

### DETAILED DESCRIPTION OF THE INVENTION

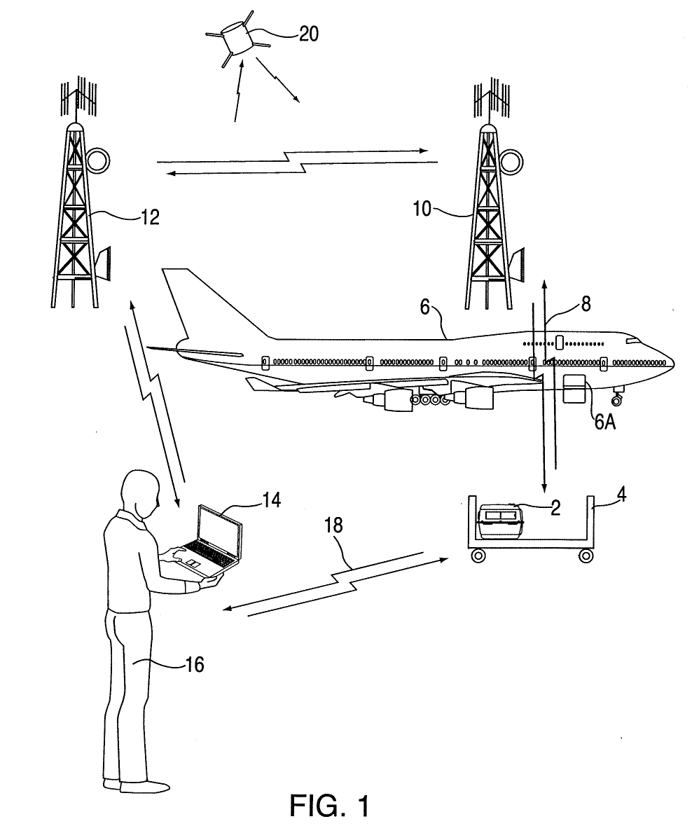

The preferred embodiments of the present invention will now be described with reference to FIGS. 1-13 of the drawings. Identical elements in the various figures are designated with the same reference numerals.

In FIG. 1, an animal travel container or carrier (2) is positioned on a luggage transporter (4) adjacent to an airplane (6) loading cargo into cargo compartment (6A). A signal (8) from animal travel carrier (2) can be transmitted to a first signal or cell tower (10), to a second signal or cell tower (12), and then to a hand-held receiver (14) held by an animal owner (16). Optionally a signal from receiver (14) could be transmitted in reverse fashion to animal travel carrier (2). Dependent upon the location and availability of facilities, a signal (18) could be communicated directly between animal travel carrier (2) and receiver (14). In a further embodiment of the invention, signals could be transmitted in other known modes, including Internet and/or satellites (20).

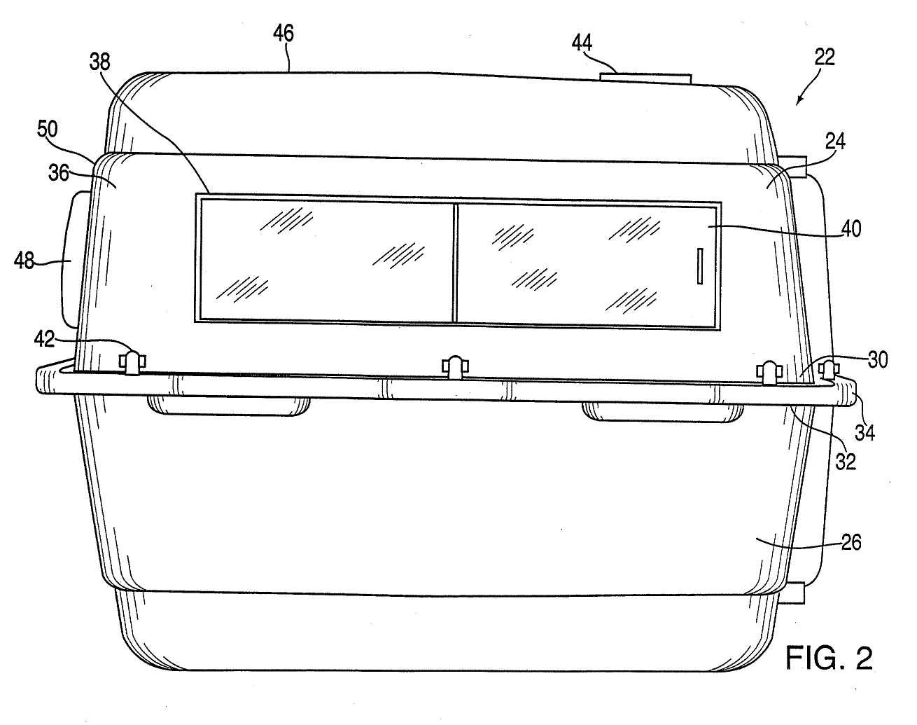

In FIG. 2, an animal travel carrier (22) may comprise a container with an upper shell member (24) and a lower shell member (26). The lower portion (30) of upper shell member (24) and the upper portion (32) of lower shell member (26) engage each other to form a projecting member (34).

Each lateral surface (36) of upper shell member (24) has an opening (38) with a sliding window (40) comprising an impact-resistant, translucent or clear polymeric material such as a PLEXIGLASS or LEXAN thermoplastic polymer or a conventional polycarbonate or polystyrene material. In other embodiments of the invention, opening (38) could comprise a grill, screening, slots or other small openings, or bars, where the slots, small openings, or bars are sufficiently close together to present the animal from escaping.

Locking connectors (42) can comprise any conventional locking system such as nuts and bolts, clamps, or other fasteners that screw or lock together. It is important that locking connectors (42) tighten and remain tightened to keep shell members (24) and (26) together during transit but can be separated when it is desired to separate shell members (24) and (26) for cleaning and/or storage.

A thermostat (44), preferably digital, is positioned on the top surface (46) of carrier (22). Thermostat (44) comprises one or more temperature sensors that measure temperature inside as well as the outside animal travel carrier (22). A climate control system (48) is positioned on or within a rear surface (50) of carrier (22). System (48) may consist of a simple low power electric fan for exhausting air from, or blowing air into, the interior of carrier (22), or system (48) may comprise a heating and/or cooling system (HVAC) where air into carrier (22) is heated by blowing over heating coils or cooling coils, respectively. System (48) is operatively connected to the thermostat (44), either or both of which are connected to or comprise a power supply, such as a battery (not shown).

In one embodiment of the invention, system (48) comprises a low power electric fan that draws air from the outside, through a heat exchanger, into the interior of animal travel carrier (22) and forces the air out of any openings in the container such as in the container surfaces or doors. Optionally a protected switch, that is, one that is not easily turned on or off (not shown), controls the electric fan and an IATA-approved power supply, such as a battery or a connection to a local power source, provides power to the fan via a thermostatic switch. The thermostat preferably controls the temperature in the interior of carrier (22) within a set range. For example, this set range could be from about 68° F. to about 72° F. Useful heating and/or cooling systems are known, including, but not limited to, a Peltier module.

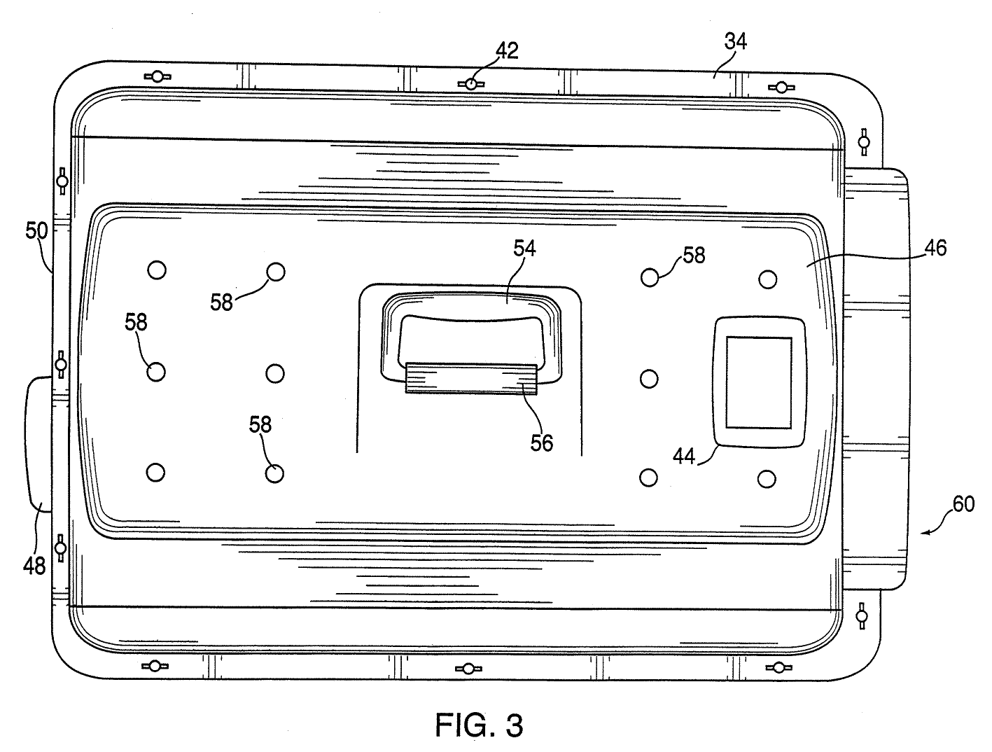

In the top view of a device according to the invention shown in FIG. 3, it can be appreciated that animal travel carrier (22) has a handle (54) engaged in handle retainer (56) and air vents (58) in top surface (46). Animal travel carrier (22) has a front surface (60) as well as rear surface (50), and projecting member (34) comprises locking connectors (42).

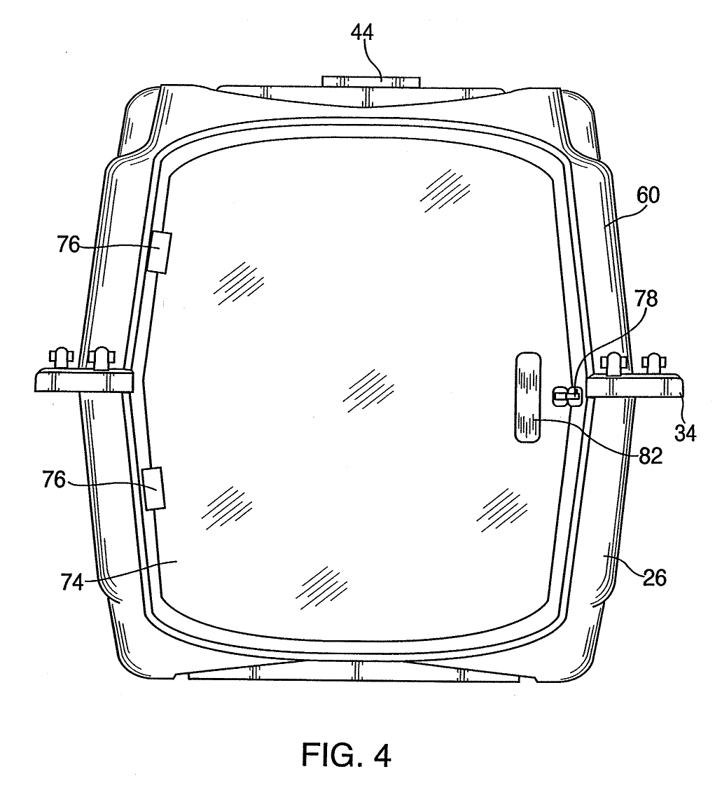

In the front view depicted in FIG. 4, a door (74) has hinges (76) and a locking mechanism (78). A handle (82) may comprise an opening or a separate member that is attached to door (74). Door (74) may be comprised of an impact-resistant, translucent or clear, polymeric material such as a PLEXIGLASS or LEXAN thermoplastic polymer or any conventional polycarbonate or polystyrene material. In other embodiments of the invention, door (74) could comprise a grill, screening, or bars, where the bars are sufficiently close together to prevent the animal from escaping.

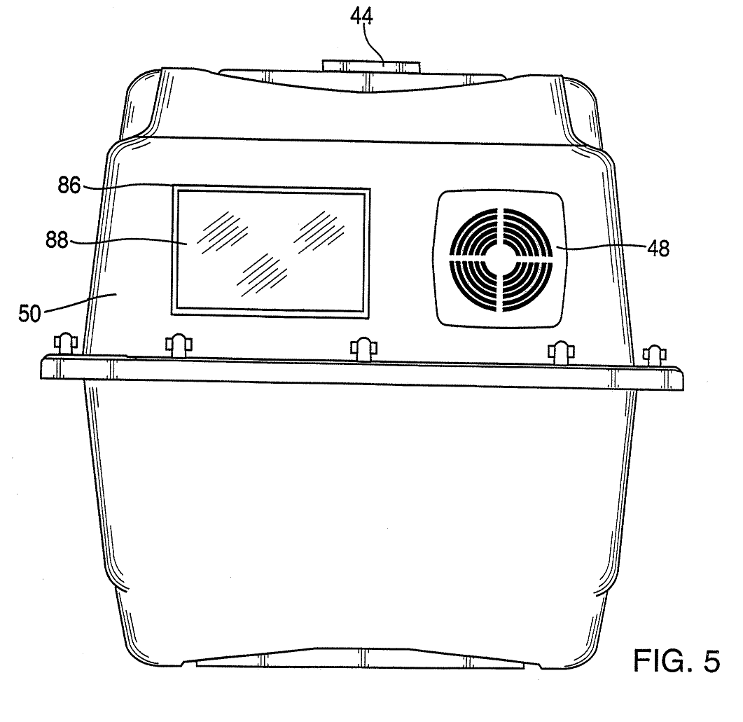

In the rear view of FIG. 5, there is an opening (86) adjacent to system (48) in the rear surface (50) of upper shell member (24). Opening (86) may have a fixed or sliding window (88) comprising an impact-resistant, translucent or clear, polymeric material such as a PLEXIGLASS or LEXAN thermoplastic polymer or any conventional polycarbonate or polystyrene material. In other embodiments of the invention, opening (86) could comprise a grill, screening, slots or other small openings, or bars, where the slots or small openings are sufficiently small, or the bars are sufficiently close together, to prevent the animal from escaping.

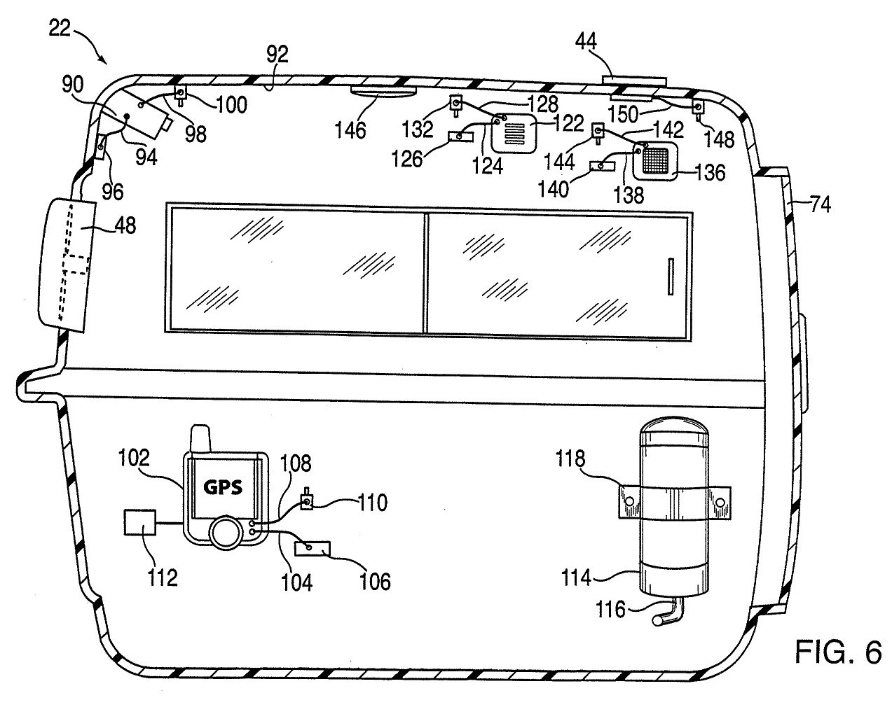

FIG. 6 is a cross-sectional, cutaway view of animal travel carrier (22) where a video camera (90) is positioned on or near the upper inner surface (92) of carrier (22). Camera (90) may comprise a transmitter to transmit images to a remote receiver (not shown). Optionally, camera (90) may contain its own battery as an electrical supply or it may be in electrical communication through wire (94) with a battery pack (96). Camera (90) may have an integrated transmitting function or it may be in communication through wire (98) with a transmitter (100). Animal carrier (22) may optionally have a GPS system (102) with a self-contained, rechargeable battery and/or self-contained transmitter. Optionally, GPS system (102) is connected through wire (104) to battery (106) and/or through wire (108) to transmitter (110). Optionally, GPS unit (102) comprises or is coupled to a timed or automated on/off switch (112), to allow suspension and/or resumption of GPS transmission. For example, GPS unit (102) unit can be programmed to suspend transmission a set time, such as 30 minutes, before an aircraft leaves its gate and/or to resume transmission a set time, such as 30 minutes, after the aircraft is to scheduled to land. GPS system (102) can be in the “on” mode after the aircraft lands, similar to a cell phone or other electronic device.

Optionally, GPS unit (102) may be responsive to the receipt of encoded commands transmitted wirelessly, to turn it on and/or off.

Preferably there is a plastic or metal water bottle (114) with a dispensing member (116) that can be remotely secured in a holder (118) within animal travel carrier (22).

Optionally, there may be (a) a listening device (122) comprising a battery or operatively connected through wire (124) to a battery (126) and/or connected through a wire (128) to a transmitter (132) or (b) a speaker or sound-generating device (136) comprising a battery or operatively connected through a wire (138) to a battery (140) and/or through a wire (142) to a receiver (144), which may receive a signal from a remote transmitter (not shown).

Transmitters (100), (110) and (132) may each transmit a signal to a remote receiver (not shown), or two or more of transmitters (100), (110), and (132) may be the same. In one embodiment of the invention listening device (122) and speaker (136) may be the same device with dual function. For example, a device comprising piezoelectric film might perform this dual function.

In a preferred embodiment of the invention, hinged door (74) has ventilation holes. Optionally a light (146) with an integrated on/off switch has an integrated battery.

In another embodiment of the invention, there may be a third receiver (148) in animal travel carrier (22) that is operatively connected through wire (150) to thermostat (44). A signal from a remote transmitter (not shown) would be capable of adjusting the temperature settings of thermostat (44) or over-riding those settings to activate system (48).

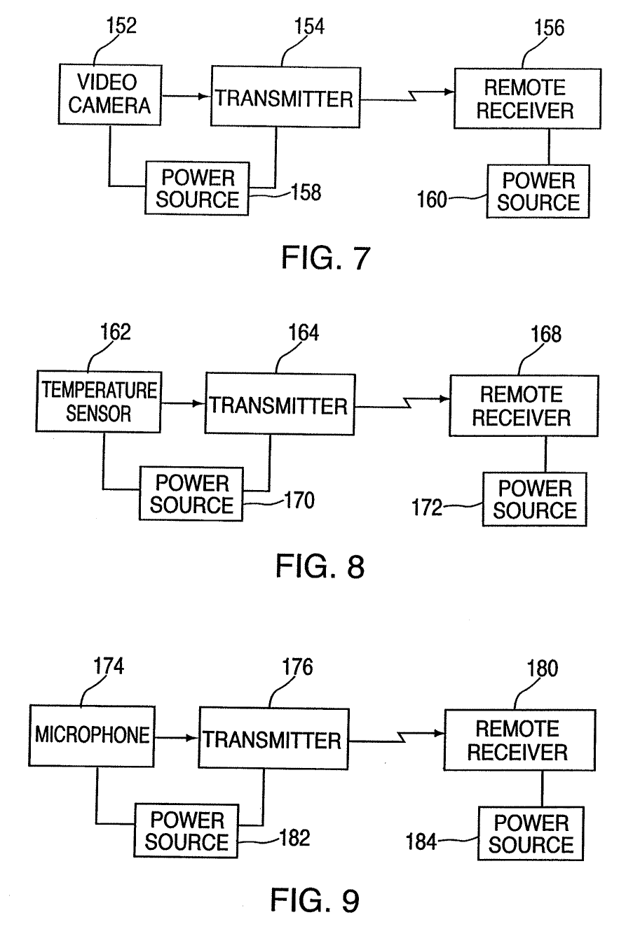

In the schematic diagram of FIG. 7, a preferred aspect of the invention is represented where a video camera (152) sends a video signal to a transmitter (154), which transmits a video signal to a remote receiver (156). Each of video camera (152) and transmitter (154) are powered by a power supply or source (158) such as one or more batteries, and receiver (156) has a separate power source (160), such as one or more batteries.

In the schematic diagram of FIG. 8, a preferred aspect to the invention is represented where a temperature sensor (162) sends a signal to a transmitter (164), which transmits a signal to a remote receiver (168). Temperature sensor (162) and transmitter (164) are each powered by a power source (170), such as one or more batteries. Receiver (168) has a separate power source (172), such as one or more batteries.

In the schematic diagram of FIG. 9, a preferred aspect of the invention is represented where a microphone (174) sends a signal to a transmitter (176), which transmits a signal to a remote receiver (180). Microphone (174) and transmitter (176) are each powered by a power source (182), such as one or more batteries. Receiver (180) has a separate power source (184), such as one or more batteries.

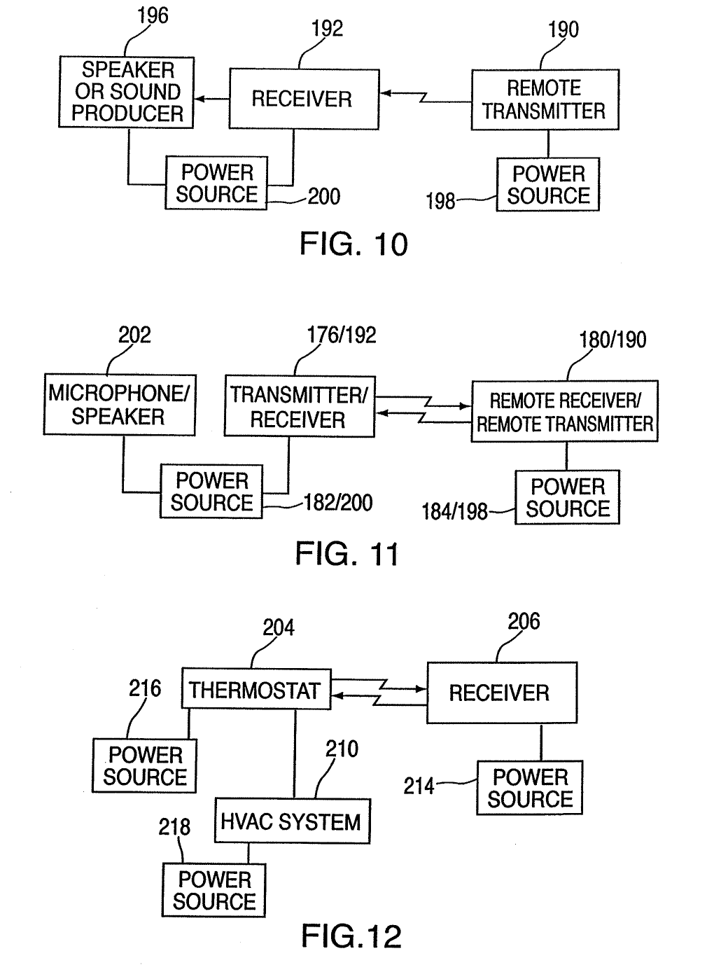

In the schematic diagram of FIG. 10, a preferred aspect of the invention is represented when a remote transmitter (190) sends a signal to a receiver (192), which sends a signal to a speaker or sound-producer (196). Transmitter (190) is powered by a power source (198), such as one or more batteries, and receiver (192) and speaker (196) are each powered by a power source (200), such as one or more batteries.

In another embodiment of the invention, the embodiments represented in FIGS. 9 and 10 can be combined where a specific device (202) can function as a microphone and a speaker. Respective transmitter (176) and receiver (192) could be combined, and remote receiver (180) and remote transmitter (190) could be combined, as shown in FIG. 11, with power sources (182/198) and (184/200).

In the schematic diagram of FIG. 12, a thermostat (204), preferably with an integrated temperature sensor, an integrated battery or other power source, and an integrated transmitter, senses the interior temperature of travel carrier (22) and sends a signal to remote receiver (206). Optionally receiver (206) may also function as a transmitter to send a signal to thermostat (204) to, for example, adjust the temperature setting or settings of thermostat (204). Thermostat (204) is in communication with HVAC system (210) to turn HVAC system (190) on or off, as required to maintain temperature settings.

Receiver (206) may have an integrated battery or a separate power source (214), such as one or more batteries, and thermostat (204) will receive power from power source (216), which may comprise one or more batteries. HVAC system (210) may have a separate power source (218), which may comprise one or more batteries.

A primary feature of the invention is the ability to view the animal being transported and to determine its environment, by one or more signals being transmitted to a remote receiver. It is preferred that a thermostat (44) in or on animal travel carrier (22) be capable of activating system (48) to ventilate and/or cool or heat carrier (22) as needed to keep the interior of carrier (22) within a predetermined temperature range.

This specification describes one or more transmitters, receivers, and/or batteries that may be used according to the invention. As would be appreciated by those skilled in the art, the video camera, climate control system, GPS, thermostat, transmitters, receivers, interior light, listening device, or sound-generating device may be powered by separate power sources or one power source, or may be combined. Similarly, a single receiver or a single transmitter within animal travel carrier (22) may perform the separate functions described above. One remote receiver may receive one or more of the signals generated by the signal-generating devices within carrier (22) or there may be two or more separate remote receivers. Optionally, there may be backup features such as one or more backup batteries or redundant transmitters or receivers.

Optionally, animal travel carrier (22) could comprise an audible or visible alarm (not shown) that indicates when the temperature within carrier (22) exceeds a maximum setting or falls below a minimum setting. Such circuitry is well known in the electronic industry and may readily be designed by a competent practitioner.

Preferably animal travel carrier (22) will comprise one or more on/off switches that will disengage one or more of the devices within carrier (22) from a battery or other power supply, especially when carrier (22) is in storage or otherwise not in use.

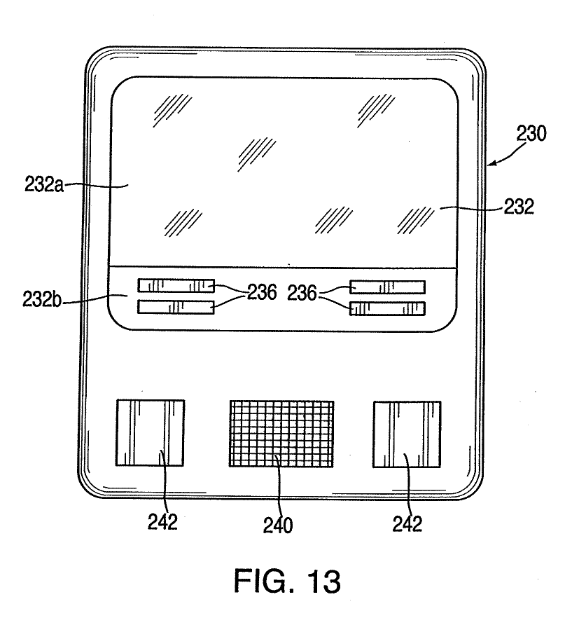

The receiver (230) set forth in FIG. 13 has a video screen (232) that primarily shows a picture of the interior of animal travel carrier (22). Video screen (232) optionally has a portion (232a) that shows the picture as well as another portion (232b) that has indicia (236) to show data such as temperature, GPS coordinates, etc. Optionally, there can be a speaker/microphone (240) and two or more switches or dials (242) for setting temperatures or otherwise sending instructions to animal travel carrier (22).

There has thus been shown and described a novel animal travel carrier which fulfills all the objects and advantages sought therefore. Many changes, modifications, variations and other uses and applications of the subject invention will, however, become apparent to those skilled in the art after considering this specification and the accompanying drawings which disclose the preferred embodiments thereof. All such changes, modifications, variations and other uses and applications which do not depart from the spirit and scope of the invention are deemed to be covered by the invention, which is to be limited only by the claims which follow.

What is claimed is:

1. An animal travel carrier suitable for use in transporting a live animal via a mode of transportation, said carrier comprising, in combination:
an enclosure of suitable size and shape for a live animal;
a source of electric power;
a video camera, connected to the power source, and arranged in the enclosure for providing a video image of the animal in the enclosure; and
a transmitter connected to said video camera, for transmitting a signal representing said video image to a remote receiver.

2. The travel carrier of claim 1, wherein the power source comprises one or more batteries.

3. The travel carrier of claim 1, wherein the power source includes a connection to a local source of power.

4. The travel carrier of claim 1, wherein the local source of power is provided on the mode of transportation.

5. The travel carrier of claim 1, further comprising a potable, temperature-regulated water supply connected to said power source.

6. The carrier of claim 1, further comprising a GPS unit connected to the power source and disposed on or within the enclosure, wherein the GPS unit provides a signal representing the location of the enclosure to said remote receiver.

7. The carrier of claim 6, wherein the GPS unit is connected to the transmitter for transmitting the location of the carrier to the remote receiver.

8. The carrier of claim 6, wherein the transmitter unit is coupled to an automatic timer that turns the transmitter unit off or on at a predetermined time.

9. The carrier of claim 1, further comprising a temperature sensor disposed in or on the enclosure, the temperature sensor being coupled to the transmitter for transmitting a signal representing the temperature inside and/or outside the enclosure to said remote receiver.

10. The carrier of claim 9, further comprising an electric heating device disposed on or in the enclosure and a thermostat for controlling the heating device to maintain a desired temperature in the enclosure.

11. The carrier of claim 9, further comprising an electric cooling device disposed on or in the enclosure and a thermostat for controlling the cooling device to maintain a desired temperature in the enclosure.

12. The carrier of claim 1, further comprising an electric light disposed on the interior of the enclosure.

13. The carrier of claim 1, which further comprises:
a video control unit connected to the video camera; and
a receiver connected to the video control unit,
wherein the receiver is operative to receive an external control signal to control the video camera.

14. The carrier of claim 1, which further comprises a listening device, connected to the power source, for detecting sound in the interior of the enclosure.

15. The carrier of claim 1, which further comprises:
a source of a sound signal,
an amplifier connected to the sound signal source, and
a speaker or other sound-producing device connected to the amplifier for producing sound to be heard by the animal.

16. The carrier of claim 15, wherein the sound signal source is a receiver for receiving the sound signal transmitted from a remote location.

17. The carrier of claim 16, further comprising a microphone and a transmitter, located remotely from said carrier, for transmitting said sound signal to said receiver, whereby a human operator may speak to the animal in the carrier.

18. A system for transporting a live animal, said system comprising, in combination:
a carrier suitable for use in transporting said animal via a mode of transportation, said carrier comprising:
an enclosure of suitable size and shape for the animal;
a video camera arranged in said enclosure for capturing a video image of a live animal in said enclosure; and
a transmitter coupled to said video camera, for transmitting a signal representing said video image to a remote receiver; and
a receiver, disposed remotely from said carrier, for receiving said signal from the transmitter on said carrier; and
an image display unit, suitable for use by a human operator and coupled to the receiver, for displaying said video image.

19. The transport system recited in claim 18, wherein the carrier further comprises a potable, temperature regulated water supply.

20. The transport system recited in claim 18, further comprising a GPS unit disposed on said enclosure, wherein said transmitter is coupled to said GPS unit for transmitting a signal representing the location of the enclosure to said receiver and wherein said image display unit is operative to display said location.

21. The transport system recited in claim 20, wherein the transmitter is coupled to an automatic timer that turns the transmitter off or on at a predetermined time.

22. The transport system recited in claim 18, further comprising a temperature sensor disposed in said enclosure, wherein said transmitter is coupled to said temperature sensor for transmitting a signal representing the temperature inside the enclosure to said receiver, and wherein said image display unit is operative to display said temperature.

23. The transport system recited in claim 18, further comprising an electric heating device disposed on said enclosure, and a thermostat for controlling the heating device to maintain a desired temperature in said enclosure.

24. The transport system recited in claim 18, further comprising an electric cooling device disposed on said enclosure, and a thermostat for controlling the cooling device to maintain a desired temperature in said enclosure.

25. The transport system recited in claim 18, wherein said carrier further comprises an electric light arranged on the inside of said enclosure, for illuminating the interior of the enclosure.

26. The transport system recited in claim 18, wherein said carrier includes a second receiver and a control unit, connected to said second receiver, for receiving a control signal, for controlling the video camera.

27. The transport system recited in claim 18, wherein said remote receiver is coupled to said image display unit via the Internet.

28. The transport system recited in claim 18, wherein said carrier further comprises a sound unit, arranged in said enclosure, for producing sound in the interior of the enclosure.

29. The transport system recited in claim 28, wherein said carrier includes a second receiver, coupled to said sound unit, for receiving a sound signal transmitted from a remote location.

30. The transport system recited in claim 29, further comprising a microphone and a transmitter, located remotely from said carrier, for transmitting said sound signal to said second receiver.
